(19) United States
(12) Patent Application Publication
(10) Pub. No.: US 2025/0360614 A1
(43) Pub. Date: Nov. 27, 2025

(54) LEGGED ROBOT CONTROL METHOD, LEGGED ROBOT, AND STORAGE MEDIUM

(71) Applicant: TENCENT TECHNOLOGY (SHENZHEN) COMPANY LIMITED, Shenzhen (CN)

(72) Inventors: Tingguang LI, Shenzhen (CN); Haojie SHI, Shenzhen (CN); Qingxu ZHU, Shenzhen (CN); Lei HAN, Shenzhen (CN); Wanchao CHI, Shenzhen (CN)

(21) Appl. No.: 19/292,699

(22) Filed: Aug. 6, 2025

Related U.S. Application Data
(63) Continuation of application No. PCT/CN2024/092821, filed on May 13, 2024.

(30) Foreign Application Priority Data
Jul. 12, 2023 (CN) 202310859169.1

(51) Int. Cl. B25J 9/16; B62D 57/032; G06N 3/008

(52) U.S. Cl. CPC B25J 9/161; B25J 9/163; B62D 57/032; G06N 3/008

(57) ABSTRACT

A legged robot control method performed by a legged robot includes obtaining proprioceptive information and external perception information, the proprioceptive information being configured for characterizing a motion state of the legged robot, and the external perception information being configured for characterizing environment information around the legged robot; inputting the proprioceptive information and the external perception information into a deep neural network, to obtain a first predicted residual outputted by the deep neural network, the first predicted residual being configured for correcting a trajectory generation parameter of a foot trajectory generator; adjusting the trajectory generation parameter of the foot trajectory generator based on the first predicted residual; and controlling the motion state of the legged robot based on a joint motion parameter outputted by the foot trajectory generator after the trajectory generation parameter is adjusted.

### CROSS-REFERENCES TO RELATED APPLICATIONS

This application is a continuation application of PCT Patent Application No. PCT/CN2024/092821, filed on May 13, 2024, which claims priority to Chinese Patent Application No. 202310859169.1, filed on Jul. 12, 2023, all of which is incorporated herein by reference in their entirety.

### FIELD OF THE TECHNOLOGY

Embodiments of the present disclosure relate to the field of robot control, and in particular, to a legged robot control method and apparatus, a legged robot, and a medium.

### BACKGROUND OF THE DISCLOSURE

Legged robots are widely used in various scenarios, such as exploration and rescue, industrial production, and medical assistance, placing higher requirements for flexibility and stability of the legged robots.

Legged robots may obtain proprioceptive information, and perform motion control based on the proprioceptive information combined with a foot trajectory generator, so that the legged robot can perform motion control in an unknown terrain condition and maintain robustness of the motion.

However, legged robots can only handle relatively simple terrains, for example, a muddy terrain. For complex terrains, such as quincuncial piles and terrains with gaps, terrain adaptability is poor, thereby leading to poor flexibility and stability of the legged robots when moving in the complex environments.

### SUMMARY

One embodiment of the present disclosure provides a legged robot control method performed by a legged robot. The method includes obtaining proprioceptive information and external perception information, the proprioceptive information being configured for characterizing a motion state of the legged robot, and the external perception information being configured for characterizing environment information around the legged robot; inputting the proprioceptive information and the external perception information into a deep neural network, to obtain a first predicted residual outputted by the deep neural network, the first predicted residual being configured for correcting a trajectory generation parameter of a foot trajectory generator; adjusting the trajectory generation parameter of the foot trajectory generator based on the first predicted residual; and controlling the motion state of the legged robot based on a joint motion parameter outputted by the foot trajectory generator after the trajectory generation parameter is adjusted.

Another embodiment of the present disclosure provides a legged robot including one or more processors and a memory containing at least one computer instruction that, when being executed, causes the one or more processors to implement: obtaining proprioceptive information and external perception information, the proprioceptive information being configured for characterizing a motion state of the legged robot, and the external perception information being configured for characterizing environment information around the legged robot; inputting the proprioceptive information and the external perception information into a deep neural network, to obtain a first predicted residual outputted by the deep neural network, the first predicted residual being configured for correcting a trajectory generation parameter of a foot trajectory generator; adjusting the trajectory generation parameter of the foot trajectory generator based on the first predicted residual; and controlling the motion state of the legged robot based on a joint motion parameter outputted by the foot trajectory generator after the trajectory generation parameter is adjusted.

Another embodiment of the present disclosure provides a non-transitory computer-readable storage medium containing at least one computer instruction that, when being executed, causes at least one processor to perform: obtaining proprioceptive information and external perception information, the proprioceptive information being configured for characterizing a motion state of the legged robot, and the external perception information being configured for characterizing environment information around the legged robot; inputting the proprioceptive information and the external perception information into a deep neural network, to obtain a first predicted residual outputted by the deep neural network, the first predicted residual being configured for correcting a trajectory generation parameter of a foot trajectory generator; adjusting the trajectory generation parameter of the foot trajectory generator based on the first predicted residual; and controlling the motion state of the legged robot based on a joint motion parameter outputted by the foot trajectory generator after the trajectory generation parameter is adjusted.

### BRIEF DESCRIPTION OF THE DRAWINGS

FIG. 1 is a schematic diagram of an implementation environment according to an exemplary embodiment of the present disclosure.

FIG. 2 is a block diagram of controlling a legged robot according to an exemplary embodiment of the present disclosure.

FIG. 3 is a flowchart of a legged robot control method according to an exemplary embodiment of the present disclosure.

FIG. 4 is a flowchart of a legged robot control process according to another exemplary embodiment of the present disclosure.

FIG. 5 is a schematic diagram of a legged robot control process according to an exemplary embodiment of the present disclosure.

FIG. 6 is a flowchart of a process of training a deep neural network according to an exemplary embodiment of the present disclosure.

FIG. 7 is a schematic diagram of a legged robot control process according to an exemplary embodiment of the present disclosure.

FIG. 8 is a schematic diagram of a simulation environment according to an exemplary embodiment of the present disclosure.

FIG. 9 is a schematic diagram of comparing leg-lifting heights according to an exemplary embodiment of the present disclosure.

FIG. 10 is a schematic diagram of joint angle changes according to an exemplary embodiment of the present disclosure.

FIG. 11 is a block diagram of a structure of a legged robot control apparatus according to an exemplary embodiment of the present disclosure.

FIG. 12 is a schematic diagram of a structure of a legged robot according to an exemplary embodiment of the present disclosure.

### DESCRIPTION OF EMBODIMENTS

To make the objectives, technical solutions, and advantages of the present disclosure clearer, the following further describes implementations of the present disclosure in detail with reference to the accompanying drawings.

Artificial intelligence (AI) involves a theory, a method, a technology, and an application system that use a digital computer or a machine controlled by a digital computer to simulate, extend, and expand human intelligence, perceive an environment, obtain knowledge, and use the knowledge to obtain an optimal result. In other words, the artificial intelligence is a comprehensive technology in computer science and attempts to understand the essence of intelligence and produce a new intelligent machine that can react in a manner similar to human intelligence. The artificial intelligence is to study the design principles and implementation methods of various intelligent machines, to enable the machines to have the functions of perception, reasoning, and decision-making.

The artificial intelligence technology is a comprehensive discipline, and relates to a wide range of fields including both hardware-level technologies and software-level technologies. Basic artificial intelligence technologies generally include a sensor, a dedicated artificial intelligence chip, cloud computing, distributed storage, a big data processing technology, a pre-trained model technology, an operating/interaction system, electromechanical integration, and the like. The pre-trained model is also referred to as a large model or a basic model, and may be widely applied to downstream tasks in various directions of the artificial intelligence after being fine-tuned. Artificial intelligence software technologies mainly include several major directions such as a computer vision technology, a speech processing technology, a natural language processing technology, and machine learning/deep learning.

The machine learning (ML) is a multi-field inter-discipline, and relates to a plurality of disciplines such as the probability theory, statistics, the approximation theory, convex analysis, and the algorithm complexity theory. The machine learning specializes in studying how a computer simulates or implements a human learning behavior to obtain new knowledge or skills, and reorganize an existing knowledge structure, to keep improving its performance. The machine learning is the core of the artificial intelligence, is a basic way to make the computer intelligent, and is applied to various fields of the artificial intelligence. The machine learning and the deep learning generally include technologies such as an artificial neural network, a confidence network, reinforcement learning, transfer learning, inductive learning, and learning from demonstration.

A deep neural network (DNN) is a technology in the field of machine learning. The deep neural network is a multi-layer unsupervised neural network. Feature learning may be performed by using an output feature of a previous layer as an input of a next layer. Features of an existing space sample are mapped to another feature space through layer-by-layer feature mapping, to learn a better feature expression for the existing input.

A long short-term memory (LSTM) is a recurrent (recursive) neural network, and is suitable for processing and predicting an important event with a very long interval and delay in a time sequence. The LSTM has various applications in the field of science and technologies. Tasks such as language translation, robot control, an image analysis, a document abstract, speech recognition, and image recognition may be completed by using the LSTM.

Technical solutions of the present disclosure mainly relate to a robot technology in the artificial intelligence technology, and mainly relate to intelligent robot control.

A robot is a mechanical and electronic device that can imitate a skill of a human or an animal and that is combined by using mechanical transmission and modern microelectronic technologies. The robot is developed based on electronic, mechanical, and information technologies. The robot is an automated machine. The machine has some intelligent capabilities, such as a perception capability, a planning capability, an action capability, and a collaborative capability, similar to those of a human or a living creature, and is an automated machine with high flexibility.

Trajectory generator: is an algorithm module configured to generate a predetermined trajectory in fields of robotics and automated control. An objective of the trajectory generator is to calculate an accurate spatial path that an end effector (such as a mechanical hand or a mechanical leg) of a mechanical arm, a robot, a robot dog, or another automated device is to follow during execution of a task. The path not only includes location information, but also may include dynamic properties such as a speed and an acceleration. A foot trajectory generator in embodiments of the present disclosure is configured for generating a motion trajectory of a foot of a legged robot.

The trajectory generator may describe a foot trajectory in a joint space planning manner by using a joint angle function, or may describe a foot trajectory by using a Cartesian space planning method and a function of a Cartesian position and posture with respect to time. In embodiments of the present disclosure, the foot trajectory generator describes a foot trajectory by using the joint space planning method and by outputting a joint motion parameter, to control a motion state of the legged robot.

The legged trajectory generator may control a trajectory generation feature based on a trajectory generation parameter, to control the motion state of the robot. The trajectory generation parameter may include a step frequency parameter, a step length parameter, a gait height parameter (a leg-lifting height parameter), and the like. In embodiments of the present disclosure, the trajectory generation parameter of the legged trajectory generator supports parameterization, and the trajectory generation parameter is parameterized by using the deep neural network based on a motion state of the legged robot itself and a surrounding environment.

The present disclosure relates to the field of robot control, and discloses a legged robot control method and apparatus, a legged robot, and a medium. The method includes: obtaining proprioceptive information and external perception information, the proprioceptive information being configured for characterizing a motion state of self of the legged robot, and the external perception information being configured for characterizing environment information around the legged robot; inputting the proprioceptive information and the external perception information into a deep neural network, to obtain a first predicted residual outputted by the deep neural network; adjusting a trajectory generation parameter of a foot trajectory generator based on the first predicted residual; and controlling a motion state of the legged robot based on a first joint motion parameter outputted by the foot trajectory generator whose parameter is adjusted. Based on solutions provided in embodiments of the present disclosure, flexibility and stability of the legged robot during motion in a complex environment are improved.

FIG. 1 is a schematic diagram of an implementation environment according to an exemplary embodiment of the present disclosure. The implementation environment includes a legged robot 110 and a quincuncial pile terrain 120. The legged robot 110 is a quadruped robot. The legged robot 110 includes a base 111, four legs 112 disposed on the base 111, and several joints corresponding to the four legs. The legged robot 110 obtains proprioceptive information characterizing a motion state of a body, and obtains external perception information characterizing environment information (the quincuncial pile terrain 120) around the legged robot 110. The legged robot 110 performs motion control by using the proprioceptive information and the external perception information, to flexibly avoid a risky gap area during advancing, so that the legged robot 110 steadily advances in the quincuncial pile terrain 120.

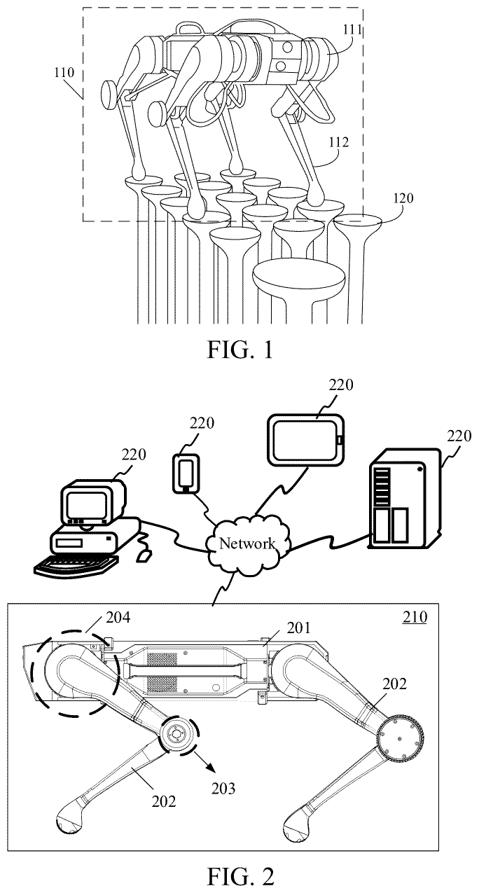

Refer to FIG. 2. FIG. 2 is a block diagram of controlling a legged robot according to an exemplary embodiment of the present disclosure. In an example, as shown in FIG. 2, a control scenario of a quadruped robot is used as an example. An implementation environment of the solution may include: a legged robot 210 and a control device 220 (exemplary).

In some embodiments, as shown in FIG. 2, the legged robot 210 includes: a body 201 (which may also be referred to as a base or a chassis) and a mechanical leg structure 202. A controller of the legged robot 210 is disposed in the body 201. The body 201 (the controller in the body) issues an instruction to the mechanical leg structure 202, to control an activity of the mechanical leg structure 202.

A plurality of joints are disposed on the mechanical leg structure 202. That is, the mechanical leg structure 202 is a multi-section leg structure, and one joint motor or a plurality of joint motors may be disposed at each joint. One of mechanical leg structures 202 is used as an example. A joint 203 and a joint 204 are disposed on the mechanical leg structure. One joint motor is disposed at the joint 203, and is configured to control thigh motion. Two joint motors are disposed at the joint 204, and are configured to control calf motion.

The control device 220 may include, but is not limited to, a mobile phone, a computer, an intelligent speech interaction device, an intelligent household appliance, an in-vehicle terminal, an aircraft, and the like. Alternatively, the control device 220 may be a server. The control device 220 may be configured to control the legged robot 210.

The legged robot 210 and the control device 220 may communicate with each other through a network, such as a wired or wireless network.

For example, after obtaining proprioceptive information and external perception information of the legged robot 210 at a current moment, the control device 220 may predict a joint motion parameter of the legged robot 210 at a next moment based on the proprioceptive information and the external perception information, and control motion of the legged robot 210 based on the predicted joint motion parameter, so that the legged robot 210 can accurately and efficiently execute an action.

In some embodiments, the process may alternatively be independently completed by the legged robot. The legged robot obtains the proprioceptive information and the external perception information. The legged robot inputs, into a deep neural network, the proprioceptive information and the external perception information on which vectorized feature processing is performed. The deep neural network outputs a first predicted residual. The first predicted residual is configured for correcting a trajectory generation parameter of a foot trajectory generator of the legged robot. The trajectory generation parameter corresponding to the foot trajectory generator may include a reference step frequency and a reference leg-lifting height. The foot trajectory generator whose parameter is adjusted outputs the joint motion parameter at the next moment. The legged robot controls a motion state of the legged robot based on the joint motion parameter.

An execution body of controlling the legged robot is not limited in embodiments of the present disclosure. For ease of description, the following embodiment is described by using an example in which the legged robot is the execution body.

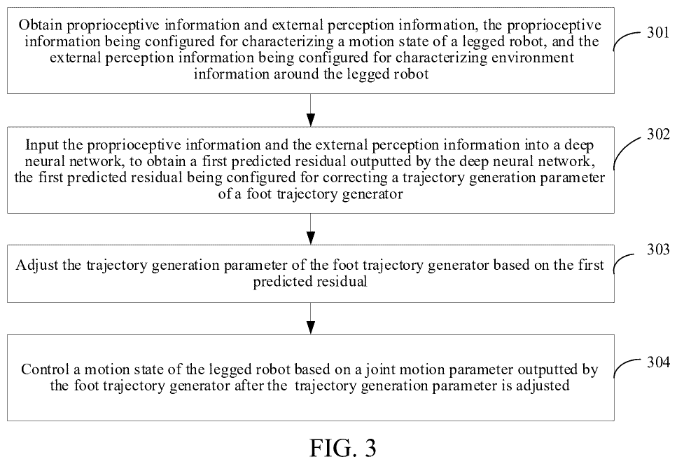

FIG. 3 is a flowchart of a legged robot control method according to an exemplary embodiment of the present disclosure. This embodiment is described by using an example in which the method is performed by a legged robot. The method includes the following operations.

Operation 301: Obtain proprioceptive information and external perception information, the proprioceptive information being configured for characterizing a motion state of a legged robot itself, and the external perception information being configured for characterizing environment information around the legged robot.

In some embodiments, the legged robot periodically obtains the proprioceptive information. The proprioceptive information may include, but is not limited to, body speed information, body rotation angle information, joint angular velocity information, joint angular acceleration information, and a direction instruction of the legged robot. An obtaining frequency of the proprioceptive information may match a trajectory generation period of a foot trajectory generator.

The body speed information may include speed information of the legged robot in directions of three axes, namely, x, y, and z, where the z axis is perpendicular to the legged robot, the x axis is a width direction of a base of the legged robot, and the y axis is a length direction of the base of the legged robot. Correspondingly, the body rotation information includes angle information of the legged robot separately rotating around the three axes, namely, x, y, and z.

In one embodiment, the body rotation angle information is represented by using an Euler angle, and the body speed information and the body rotation angle information may be collected by an inertial measurement unit disposed on the legged robot. The legged robot may obtain a joint angular velocity and a joint angular acceleration from an encoder corresponding to each joint. In addition, the legged robot may receive a direction instruction transmitted by a user. The direction instruction is configured for indicating a motion direction of the legged robot.

In some embodiments, the legged robot periodically obtains the external perception information. The external perception information is configured for characterizing environment information around the legged robot. The external perception information includes, but is not limited to, terrain information around the legged robot, including, but not limited to, terrain height information, geological information, and the like. The legged robot may obtain the terrain height information, to perceive whether a surrounding terrain is continuous or has a gap, and obtain the geological information, to perceive whether the surrounding terrain is environment information (for example, a field) that is suitable for advancing or environment information (for example, a pit) that is unsuitable for advancing. An obtaining frequency of the external perception information may match the trajectory generation period of the foot trajectory generator.

The external perception information may be collected in a plurality of manners. For example, the external perception information is collected by a visual sensor disposed on the legged robot, or the terrain information may be collected by using a light detection and ranging (LiDAR) sensor.

Certainly, in another embodiment, the external perception information may further include admission information, and the admission information is configured for indicating whether an area around the legged robot can be entered. Alternatively, the external perception information may further include weather information, and the weather information is configured for indicating a weather state around the legged robot, such as raining, snowing, temperature, or humidity. Specific content of the external perception information is not limited in embodiments of the present disclosure.

In one embodiment, the external perception information may be collected by using an action capture technology. A plurality of cameras are disposed in an external environment of the legged robot, to collect a terrain map, and to obtain relative coordinates between a location of the legged robot and the terrain map. The legged robot receives the coordinates to generate a terrain height map, and uses the terrain height map as the external perception information.

Operation 302: Input the proprioceptive information and the external perception information into a deep neural network, to obtain a first predicted residual outputted by the deep neural network, the first predicted residual being configured for correcting a trajectory generation parameter of the foot trajectory generator.

In some embodiments, the legged robot has a foot trajectory generator (TG), and the foot trajectory generator is configured to generate a motion trajectory of each leg of the legged robot at a next moment. The foot trajectory generator provides prior knowledge to a controller of the legged robot, so that the legged robot can perform motion control based on reference information outputted by the foot trajectory generator. In one embodiment, the legged robot may alternatively use an independent policy modulating trajectory generator (PMTG) on each leg.

The foot trajectory generator in embodiments of the present disclosure is not a foot trajectory generator with a fixed parameter, but a foot trajectory generator supporting parameterization. In other words, the trajectory generation parameter configured for generating a foot trajectory in the foot trajectory generator supports a dynamic adjustment, thereby improving adaptability to different environments.

In some embodiments, the trajectory generation parameter of the foot trajectory generator is parameterized by using the deep neural network.

In some embodiments, the trajectory generation parameter of the foot trajectory generator includes at least one of a step frequency parameter, a step length parameter, and a leg-lifting height parameter (a gait height parameter). The step frequency parameter is configured for controlling a step frequency of the legged robot, the step length parameter is configured for controlling a step length of the legged robot, and the leg-lifting height parameter is configured for controlling a leg-lifting height of the legged robot.

In some embodiments, due to changes in the proprioceptive information and the external perception information of the legged robot, a motion state, predicted by the foot trajectory generator, of the legged robot at a next moment has a deviation from an actual motion state of the legged robot at the next moment. Therefore, the legged robot inputs the proprioceptive information and the external perception information into the deep neural network, predicts a deviation between the actual motion state and the predicted motion state of the legged robot by using the deep neural network, and determines the first predicted residual based on the deviation, so that the legged robot can subsequently adjust the trajectory generation parameter of the foot trajectory generator based on the first predicted residual. In some embodiments, before the residual prediction is performed by using the deep neural network, the proprioceptive information and the external perceptual information need to be vectorized, to obtain an proprioceptive vector and an external perception vector, and the proprioceptive vector and the external perception vector are fused, so that a fusion result is inputted into the deep neural network.

Operation 303: Adjust the trajectory generation parameter of the foot trajectory generator based on the first predicted residual.

In some embodiments, the legged robot adjusts the trajectory generation parameter of the foot trajectory generator based on a first predicted residual, so that the foot trajectory generator can more accurately predict the motion state of the legged robot at the next moment, to output more accurate reference information (a joint motion parameter).

In one embodiment, the legged robot adjusts all or some of trajectory generation parameters based on the first predicted residual. For example, the legged robot adjusts the step frequency parameter based on the first predicted residual, the legged robot adjusts the leg-lifting height parameter based on the first predicted residual, or the legged robot adjusts the step frequency parameter and the leg-lifting height parameter based on the first predicted residual.

Operation 304: Control a motion state of the legged robot based on the joint motion parameter outputted by the foot trajectory generator whose parameter is adjusted.

In some embodiments, after the legged robot performs the parameter adjustment on the foot trajectory generator based on the first predicted residual, the foot trajectory generator can output the more accurate joint motion parameter at the next moment, so that the legged robot can control a motion state of a foot based on the joint motion parameter.

In one embodiment, a controller of the legged robot determines, based on the joint motion parameter outputted by the foot trajectory generator, a motor output (for example, motor output torque) of a motor at each joint, so that the joint is driven by using the motor to perform motion, thereby enabling the legged robot to perform motion.

In conclusion, in embodiments of the present disclosure, a parameterized foot trajectory generator is introduced. The foot trajectory generator supports adjusting the trajectory generation parameter by using the deep neural network. When the parameter adjustment is performed on the foot trajectory generator by using the deep neural network, the proprioceptive information characterizing the motion state of the legged robot itself and the external perception information characterizing a surrounding environment of the legged robot are combined. Therefore, compared with a foot trajectory generator with a fixed parameter, the foot trajectory generator supporting parameterization can generate a foot trajectory better conforming to a current environment. Further, the legged robot is controlled based on the joint motion parameter outputted by the foot trajectory generator whose parameter is adjusted, so that flexibility and stability of the legged robot during motion in a complex environment can be improved.

In a possible design, in addition to outputting the first predicted residual configured for adjusting the trajectory generation parameter, the deep neural network further outputs a second predicted residual configured for correcting the joint motion parameter. When the motion state of the legged robot is controlled based on the joint motion parameter outputted by the foot trajectory generator whose parameter is adjusted, the legged robot corrects, based on the second predicted residual, the joint motion parameter outputted by the foot trajectory generator, to control the motion state of the legged robot based on a corrected joint motion parameter.

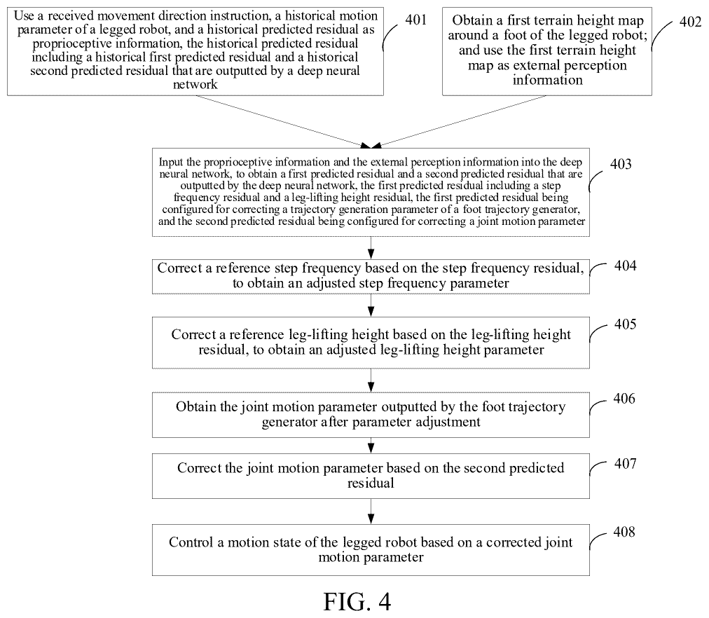

FIG. 4 is a flowchart of a legged robot control process according to another exemplary embodiment of the present disclosure. This embodiment is described by using an example in which the process is performed by a legged robot. The method includes the following operations.

Operation 401: Use a received movement direction instruction, a historical motion parameter of the legged robot, and a historical predicted residual as proprioceptive information, the historical predicted residual including a historical first predicted residual and a historical second predicted residual that are outputted by a deep neural network.

In some embodiments, the deep neural network is an LSTM network. Therefore, the legged robot may input corresponding historical motion state information into the LSTM network, predict a motion state at a next moment based on a historical motion state by using the LSTM network, and output a first predicted residual. In this case, the legged robot adjusts a trajectory generation parameter of a trajectory generator based on the first predicted residual, so that the trajectory generator outputs a more accurate joint motion parameter at the next moment, and the legged robot performs motion control based on the joint motion parameter.

In one embodiment, the historical motion state information includes a historical motion parameter of the legged robot.

In some embodiments, in addition to using the historical motion state information as an input, the movement direction instruction and the historical predicted residual (a predicted residual outputted by the deep neural network in a historical period) may further be used as inputs.

In some embodiments, the movement direction instruction is a direction instruction that is received by the legged robot and that is transmitted by a user, and is configured for indicating a motion direction of the legged robot. The historical motion parameter of the legged robot is a joint motion parameter generated by the legged robot at a historical moment. The historical predicted residual may include the historical first predicted residual (configured for adjusting the trajectory generation parameter), or include the historical first predicted residual and the historical second predicted residual (configured for correcting the joint motion parameter).

In some embodiments, the first predicted residual includes a step frequency residual and a leg-lifting height residual. The step frequency residual and the leg-lifting height residual are respectively configured for correcting a step frequency parameter and a leg-lifting height parameter of the foot trajectory generator. Correspondingly, the historical first predicted residual includes a historical step frequency residual and a historical leg-lifting height residual. The second predicted residual is configured for correcting the joint motion parameter outputted by the foot trajectory generator. Correspondingly, the historical second predicted residual is a corresponding second predicted residual of the legged robot at the historical moment, and is configured for correcting a historical joint motion parameter outputted by the foot trajectory generator.

Operation 402: Obtain a first terrain height map around a foot of the legged robot. The first terrain height map is used as external perception information.

In some embodiments, the external perception information reflects a terrain state around the legged robot. The legged robot may generate a first terrain height map based on a terrain height around the legged robot, and use the first terrain height map as the external perception information. The first terrain height map may be obtained by using the following method:

sampling ground heights based on at least two sampling radiuses by using the foot of the legged robot as a center, to obtain at least two ground sampling point heights.

In one embodiment, for each leg of the legged robot, the legged robot samples ground heights on circumferences with different radiuses using a foot corresponding to each leg as a circle center, to obtain a plurality of ground sampling point heights.

The ground sampling point height may be represented aspᵢⱼ, where i represents an i^{th} leg of the legged robot, and j represents a j^{th} sampling point. If n points are sampled on each leg of the legged robot, j={1, 2, . . . , n}. After determining the ground sampling point height, the legged robot may compare the ground sampling point height with a height of the foot, to obtain external perception state information of the legged robot.

For example, for a quadruped robot, four feet are used as circle centers. Ground heights are sampled on each leg with radiuses of 0.5 m and 1 m, and sampling is performed once on each sampling radius, so that each leg corresponds to two ground sampling points (n=2), and sampling is performed on four legs eight times in total. Correspondingly, eight ground sampling point heights may be obtained.

Further, the legged robot generates the first terrain height map based on a difference between the height of the foot and the ground sampling point height.

In one embodiment, the legged robot calculates a difference based on the height of the foot of each leg and the ground sampling point height corresponding to each leg, and generates the first terrain height map based on the difference and location coordinates corresponding to the ground sampling point. The first terrain height map may represent a difference between a current height of the foot of the legged robot and a height of a terrain around the foot.

For example, for a quadruped robot, four feet are used as circle centers. Ground heights are sampled on each leg with radiuses of 0.5 m and 1 m, sampling is performed once on each sampling radius, sampling is performed twice in total on each leg to obtain two ground sampling points (n=2), and two ground sampling point heights are obtained. The two ground sampling point heights are separately subtracted from the height of the foot corresponding to the leg, and the first terrain height map is generated based on height differences and the locations of the ground sampling points. A left front leg is used as an example, a height of a foot corresponding to the left front leg is 0.3 m, and two ground sampling point heights corresponding to the left front leg are 0.4 m and 0.3 m. Therefore, height differences between the height of the foot of the left front leg and the ground sampling point heights are 0.1 m and 0 m. The height differences are combined with locations of ground sampling points corresponding to the left front leg, to generate terrain height information around the left front leg. The remaining three legs can be deduced by analogy. The first terrain height map is generated based on terrain height information around each leg.

In some other embodiments, the legged robot obtains a second terrain height map of an area of a specific shape below a reference location; and uses the second terrain height map as the external perception information.

In one embodiment, to improve effectiveness of the generated terrain height map, the reference location may be located at a middle location of the legged robot, and the area of the specific shape is greater than a projection area of the legged robot. For example, the reference location is located at a middle location of a body of the legged robot, and the area of the specific shape is a circular area whose diameter is greater than a length of the legged robot. A specific disposition location of the reference location, and a specific form and size of the area of the specific shape are not limited in embodiments of the present disclosure.

In some embodiments, a collection component is disposed at the reference location of the legged robot, and the collection component is configured to perform height sampling on the following area of the specific shape, to obtain the second terrain height map. The collection component may be a ranging component (such as a ToF ranging component, an infrared ranging component, or a LiDAR sensor) or a photographing component.

In one embodiment, the legged robot obtains a reference location of a body, and obtains the second terrain height map of the area of the specific shape by using the reference location as a center. For example, for a quadruped robot, a second terrain height map of a circular area whose radius is 1 m is obtained by using the reference location of the body as a center, or a second terrain height map of a square area whose side length is 1 m is obtained by using the reference location of the body as a center.

Certainly, in addition to the foregoing two manners of obtaining a terrain height map, the legged robot may further obtain the terrain height map in another manner. For example, based on location coordinates of the legged robot, a terrain height map in a predetermined range corresponding to the location coordinates is obtained from a pre-constructed environment terrain height map. This is not limited in this embodiment.

Operation 403: Input the proprioceptive information and the external perception information into the deep neural network, to obtain the first predicted residual and the second predicted residual that are outputted by the deep neural network, the first predicted residual including the step frequency residual and the leg-lifting height residual, the first predicted residual being configured for correcting the trajectory generation parameter of the foot trajectory generator, and the second predicted residual being configured for correcting the joint motion parameter.

In some embodiments, the legged robot inputs the received movement direction instruction, the historical motion parameter of the legged robot, and the historical predicted residual into the LSTM network as the proprioceptive information, and the legged robot inputs the first terrain height map (or the second terrain height map) into the deep neural network as the external perception information, so that the LSTM network predicts the motion state of the legged robot at the next moment based on a historical motion state of the legged robot and an external environment state, and outputs the first predicted residual. The step frequency residual and the leg-lifting height residual in the first predicted residual are configured for correcting the step frequency parameter and the leg-lifting height parameter of the foot trajectory generator.

Operation 404: Correct a reference step frequency based on the step frequency residual, to obtain an adjusted step frequency parameter.

In some embodiments, the legged robot has a preset reference step frequency, and the foot trajectory generator corrects the reference step frequency by using the step frequency residual outputted by the LSTM network, to obtain the adjusted step frequency parameter, so that after the parameter adjustment, the foot trajectory generator can more accurately predict the motion state of the legged robot at the next moment based on a dynamic step frequency, and output a more accurate joint motion parameter. The step frequency parameter may be a sum of the reference step frequency and the step frequency residual, and the step frequency residual may be a positive value or a negative value.

In a possible application scenario, it is set that the reference step frequency is f_{base} and the step frequency residual outputted by the LSTM network is δf. Therefore, the adjusted step frequency parameter fₜ is:

$${f}_{t} = {f}_{base} + δ f$$

Operation 405: Correct a reference leg-lifting height based on the leg-lifting height residual, to obtain an adjusted leg-lifting height parameter.

In some embodiments, the legged robot has a preset reference leg-lifting height, and the foot trajectory generator corrects the reference leg-lifting height by using the leg-lifting height residual outputted by the LSTM network, to obtain the adjusted leg-lifting height parameter, so that after the parameter adjustment, the foot trajectory generator can more accurately predict the motion state of the legged robot at the next moment based on a dynamic leg-lifting height, and output a more accurate joint motion parameter. The leg-lifting height parameter may be a sum of the reference leg-lifting height and the leg-lifting height residual, and the leg-lifting height residual may be a positive value or a negative value.

In a possible application scenario, it is set that the reference leg-lifting height is H, and the leg lift height residual outputted by the LSTM network is δh. Therefore, the adjusted leg-lifting height parameter Hₜ is:

$${H}_{t} = H + δ h$$

There is no strict execution sequence between operation 404 and operation 405.

Operation 406: Obtain the joint motion parameter outputted by the foot trajectory generator whose parameter is adjusted.

In some embodiments, after adjusting the step frequency parameter and the leg-lifting height parameter, the foot trajectory generator can output the relatively accurate joint motion parameter. The joint motion parameter may be torque of each joint of the legged robot. In one embodiment, the joint motion parameter may be obtained by using the following method:

The legged robot obtains, based on a step frequency parameter and a leg-lifting height parameter that are adjusted by the foot trajectory generator and with reference to a motion state of each leg of the legged robot, a plantar location corresponding to each leg, then calculates, by using inverse kinematics (IK), a target motor location corresponding to the plantar location, finally, calculates, by using a proportional integral derivative (PID) controller, torque corresponding to each joint, and uses the torque as the joint motion parameter.

In one embodiment scenario, the legged robot is a quadruped robot, and a motion state of each leg is represented by using a phase p∈[0, 2π]. When the legged robot uses a trotting gait, and a phase of a left front leg is given, phases of the remaining three legs (namely, a right front leg p_{RF}, a left rear leg p_{LR}, and right rear leg p_{RR}) may be calculated:

$${p}_{RR} = {p}_{LF} and {p}_{RF} = {p}_{LR} = {p}_{LF} + π .$$

However, the phase of the left front leg may be calculated based on a phase of the left front leg of the legged robot at a previous moment, a step frequency, and a unit time step length by using the following formula:

$${p}_{t} = {p}_{t - 1} + {f}_{t} T$$

where in the formula: pₜ represents a phase of the left front leg at a current moment, pₜ₋₁ represents a phase of the left front leg at a previous moment, fₜ represents the step frequency, and T is the unit time step length. The unit time step length may be calculated based on a frequency of outputting a signal by the deep neural network. For example, if a deep neural network outputs a signal 50 times within 1 s, that is, transmits a signal once every 0.02 s (20 ms), the unit time step length is 0.02 s (20 ms).

After the phase of each leg of the legged robot is obtained, regularization processing is performed on the phase for subsequently calculating the plantar location corresponding to each leg, where q is a leg phase obtained after the regularization processing:

$$q = \vert \frac{{p}_{i}}{π} \vert$$

To obtain the joint motion parameter, the plantar location corresponding to each leg of the legged robot needs to be first calculated, so that the target motor location corresponding to the plantar location is calculated by using the inverse kinematics, to perform PID to obtain the joint motion parameter (the torque). The plantar location corresponding to each leg is equal to a reference plantar location plus a plantar location residual. Because the reference plantar location of each leg is a default value, only the plantar location residual corresponding to each leg needs to be calculated, and the plantar location residual corresponding to each leg may be calculated by using the following formula:

$${d}_{l} = - ( 2 {q}^{3} - 3 {q}^{2} + 1 ) + 0.5 \\ {d}_{x} = {c}_{x} * {d}_{l} \\ {d}_{y} = {c}_{y} * {d}_{l} \\ t = 2 {p}_{i} / π \\ {d}_{z} = \{ \begin{matrix}0 , & {p}_{i} \leq 0 \\ ( - 2 {t}^{3} + 3 {t}^{2} ) ( H + δ h ) , & 0 < {p}_{i} \leq π / 2 \\ ( 2 {t}^{3} + 3 {t}^{2} + 1 ) ( H + δ h ) , & {p}_{i} > π / 2\end{matrix}$$

In the foregoing formula, dₓ, d_{y}, and d_{z} are quantities to be solved, and dₓ, d_{y}, and d_{z} respectively represent plantar location residuals of each leg of the legged robot in an x-axis direction, a y-axis direction, and a z-axis direction, pi represents a phase of an i^{th} leg, q represents a regularized phase, and t is similar to q that is an intermediate quantity for further processing the phase of the i^{th} leg, and is configured for subsequent calculation. dₗ ∈[−0.5,0.5] is an intermediate quantity for normalization processing of the leg phases. When dₓ and d_{y} are to be solved, two intermediate quantities cₓ and c_{y} are further required to participate in calculation, cₓ and c_{y} separately represent displacements generated when the legged robot moves in the x-axis direction and the y-axis direction according to the movement direction instruction, and cₓ and c_{y} may be calculated by using the following formula:

$${c}_{x} = L cos θ \\ {c}_{y} = L sin θ$$

In the formula, Lis a known quantity, represents a reference step length of the legged robot, and θ is an angle between a movement direction indicated by the movement direction instruction and a current movement direction of the legged robot.

By means of the foregoing calculation process, the legged robot may obtain the plantar location (dₓ+X,d_{y}+Y,d_{z}+Z) that corresponds to each leg and that is outputted by the foot trajectory generator, where X, Y, and Z are respectively reference plantar locations in the x-axis direction, the y-axis direction, and the z-axis direction of each leg of the legged robot.

The legged robot calculates, by using inverse kinematics based on the plantar location being (dₓ+X,d_{y}+Y,d_{z}+Z) that corresponds to each leg and that is outputted by the foot trajectory generator, the target motor location corresponding to the plantar location, and obtains, by using the PID, the torque corresponding to each joint. The legged robot uses the torque corresponding to each joint as the joint motion parameter.

Operation 407: Correct the joint motion parameter based on the second predicted residual.

In some embodiments, after inputting the proprioceptive information and the external perception information into the LSTM network, when obtaining the first predicted residual outputted by the deep neural network, the legged robot may further obtain the second predicted residual. The second predicted residual may be a joint motion residual corresponding to each joint of the legged robot. The legged robot corrects, based on the joint motion residual, the joint motion parameter outputted by the foot trajectory generator, so that a predicted joint motion state represented by a corrected joint motion parameter is closer to a real joint motion state. In one embodiment, the LSTM network may be a deep neural network obtained through reinforcement learning training. Therefore, the legged robot may obtain an action based on the LSTM network by setting a policy and observing a state, and use the action as an output quantity of the LSTM network. Therefore, the legged robot may set, based on a requirement, action space corresponding to the action, to determine the output quantity of the LSTM network.

An example in which the legged robot is a quadruped robot and three joints are disposed on each leg of the quadruped robot is used. The legged robot sets action space, to enable the action space to include actions in fourteen dimensions. Actions in the former two dimensions represent a step frequency residual and a leg-lifting height residual, and actions in the latter 12 dimensions represent joint motion residuals respectively corresponding to 12 joints of the legged robot. The actions in the former two dimensions are used as first predicted residuals outputted by the LSTM network, and the actions in the latter 12 dimensions are used as second predicted residuals outputted by the LSTM network. The second predicted residuals are joint motion residuals corresponding to each joint of the legged robot, and the legged robot corrects, based on the joint motion residuals, joint motion parameters, outputted by the foot trajectory generator, of the 12 joints.

In some embodiments, the deep neural network may alternatively output only the first predicted residual, and does not need to output the second predicted residual for correcting the joint parameter outputted by the foot trajectory generator. This is not limited in this embodiment. The legged robot may adjust the trajectory generation parameter of the foot trajectory generator by using the obtained first predicted residual, and control the motion state of the legged robot based on the joint motion parameter outputted by the foot trajectory generator whose parameter is adjusted.

Operation 408: Control the motion state of the legged robot based on the corrected joint motion parameter.

In some embodiments, the joint motion parameter may be joint torque corresponding to the joint of the legged robot. The legged robot may determine a joint motor location by using the joint motion parameter (the joint torque), to adjust each joint motor location, to control the motion state of the legged robot.

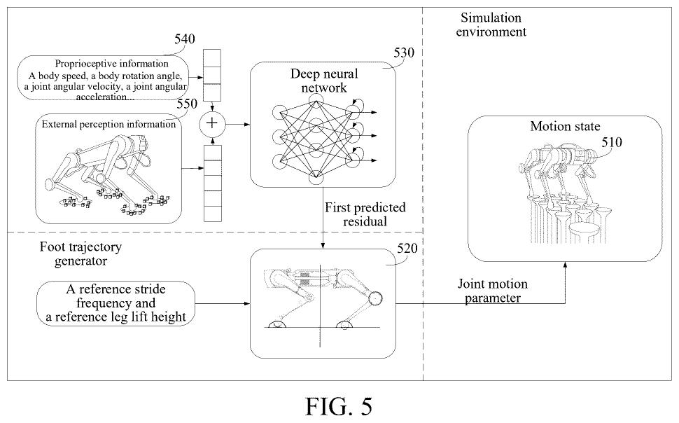

Refer to FIG. 5. FIG. 5 is a schematic diagram of a legged robot control process according to the foregoing embodiment. FIG. 5 includes a legged robot 510, a foot trajectory controller 520, and a deep neural network 530. In the figure, an example in which the legged robot is a quadruped robot is used. The legged robot 510 obtains proprioceptive information 540 and external perception information 550, and inputs, into the deep neural network 530, the proprioceptive information 540 and the external perception information 550 on which vectorized feature processing is performed. The deep neural network 530 outputs a first predicted residual. The first predicted residual is configured for adjusting a reference step frequency and a reference leg-lifting height of the foot trajectory generator 520. The foot trajectory generator 520 whose parameter is adjusted outputs a joint motion parameter at a next moment. The legged robot 510 performs motion control based on the joint motion parameter at the next moment.

In conclusion, in embodiments of the present disclosure, an LSTM network is used as the deep neural network. The legged robot first uses a received movement direction instruction, a historical motion parameter of the legged robot, and a historical predicted residual as the proprioceptive information. Meanwhile, the legged robot obtains a terrain height map around a foot, and uses the terrain height map as the external perception information, so that the legged robot perceives an external environment state while perceiving a body state. Then, the legged robot inputs the proprioceptive information and the external perception information into the LSTM network, to obtain the first predicted residual and a second predicted residual that are outputted by the deep neural network. The legged robot adjusts a step frequency parameter and a leg-lifting height parameter that are in the foot trajectory generator based on a step frequency residual and a leg-lifting height residual that are in the first predicted residual, to obtain a more accurate joint motion parameter outputted by the foot trajectory generator compared with a joint motion parameter used before the parameter adjustment. Then, the legged robot corrects the joint motion parameter again based on the second predicted residual outputted by the LSTM network, so that a predicted joint motion state represented by a corrected joint motion parameter is closer to a real joint motion state. The legged robot may control a motion state of the legged robot based on the corrected joint motion parameter. Because the proprioceptive information and the external perception information are introduced in a motion control process, the legged robot may adapt to different environments and steadily advance in the different environments, thereby improving flexibility and stability of the legged robot during motion in a complex environment.

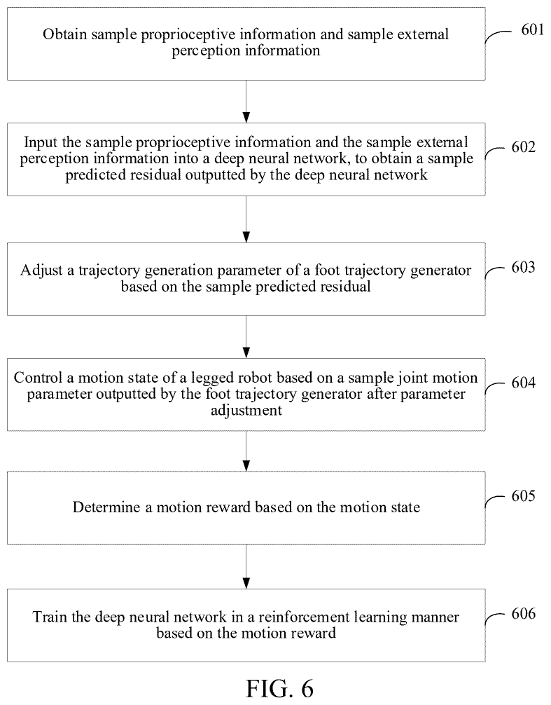

In the motion control process of the legged robot, the legged robot inputs the proprioceptive information and the external perception information into the deep neural network, and obtains the first predicted residual through prediction by using the deep neural network. A more accurate network model parameter corresponding to the deep neural network leads to a correspondingly more accurate first predicted residual outputted by the deep neural network. Therefore, the legged robot may obtain sample proprioceptive information and sample external perception information in advance, train the deep neural network in a reinforcement learning manner, and continuously optimize the deep neural network, so that the first predicted residual outputted by the deep neural network has higher precision, thereby improving accuracy of the parameter adjustment of the foot trajectory generator. As shown in FIG. 6, FIG. 6 is a flowchart of a process of training a deep neural network according to an exemplary embodiment of the present disclosure. The training process includes the following operations.

Operation 601: Obtain sample proprioceptive information and sample external perception information.

For a process of obtaining the sample proprioceptive information and the sample external perception information, refer to the foregoing process of obtaining the proprioceptive information and the external perception information. Details are not described herein again in this embodiment.

Operation 602: Input the sample proprioceptive information and the sample external perception information into the deep neural network, to obtain a sample predicted residual outputted by the deep neural network.

In some embodiments, the sample predicted residual may include a first sample predicted residual, or include a first sample predicted residual and a second sample predicted residual. The first sample predicted residual is configured for adjusting a trajectory generation parameter, and the second sample predicted residual is configured for correcting a joint motion parameter.

Operation 603: Adjust a trajectory generation parameter of a foot trajectory generator based on the sample predicted residual.

In some embodiments, a legged robot adjusts the trajectory generation parameter of the foot trajectory generator based on the first sample predicted residual.

Operation 604: Control a motion state of the legged robot based on a sample joint motion parameter outputted by the foot trajectory generator whose parameter is adjusted.

In some embodiments, when the sample predicted residual includes only the first sample predicted residual, the legged robot controls foot motion based on the sample joint motion parameter outputted by the foot trajectory generator. When the sample predicted residual further includes the second sample predicted residual, the legged robot corrects the sample joint motion parameter by using the second sample predicted residual, to control foot motion based on a corrected sample joint motion parameter.

Operation 605: Determine a motion reward based on the motion state.

In some embodiments, a motion process of the legged robot (that is, the process of training the deep neural network) may be considered as a partially observable Markov decision process (POMUDP) that is represented as <S, A, R, P, γ>, where S and A respectively represent a state and action space. R represents a reward function, P is a state transition probability, and γ∈(0, 1) is a reward discount coefficient.

The legged robot takes an action a in a current motion state, to obtain a scalar reward r, and then transfers to a next motion state s. A discounted reward in this process may be obtained with reference to state transition probability distribution and the reward discount coefficient. An overall training objective is to find an optimal policy to maximize a future discounted reward.

In a training process, if the action a of the legged robot may obtain a positive reward, a tendency of the legged robot to generate the action later is strengthened. If the action a of the legged robot obtains a negative reward (a penalty), a tendency of the legged robot to generate the action is weakened. In a motion process of the legged robot, the legged robot continuously feeds back a reward to the deep neural network based on the motion state of the legged robot, so that the deep neural network dynamically adjusts a parameter based on the reward, thereby optimizing the deep neural network. Therefore, in the training process, establishment of the motion reward and the reward function corresponding to the motion reward is particularly important.

In some embodiments, the legged robot may determine the motion reward based on the motion state in at least one of the following manners:
1. The motion reward includes at least one of an in-instruction speed reward and an out-of-instruction speed reward, and the in-instruction speed reward and the out-of-instruction speed reward are configured for encouraging the legged robot to move along an expected direction and at an expected speed. A process of determining the motion reward based on the motion state may include the following operations:

In some embodiments, the legged robot obtains a body speed of the legged robot and a movement direction indicated by a movement direction instruction; determines a default reward value as a first speed reward value when the body speed is greater than an expected lower speed limit and less than an expected upper speed limit; and uses the first speed reward value as the in-instruction speed reward.

In one embodiment, the body speed of the legged robot may be divided into a sub-speed in an instruction direction (an instruction direction speed) and a sub-speed in a non-instruction direction (a non-instruction direction speed) based on the movement direction instruction. It is hoped that the legged robot can move in the expected direction indicated by the instruction. In addition, when the instruction direction speed in the body speed falls within an expected speed range, it is considered that a movement speed of the legged robot in this case meets a requirement, and a reward (the first speed reward value) corresponding to an action of the legged robot at a current moment is a positive reward, thereby encouraging the legged robot to move along the expected direction and at the expected speed. The default reward value may be a value preset by the legged robot. For example, the default reward value is set to 1.

In some embodiments, a second speed reward value is determined based on the body speed, the movement direction, and the expected lower speed limit when the body speed is less than the expected lower speed limit; and the second speed reward value is used as the in-instruction speed reward, the second speed reward value being less than the default reward value.

In one embodiment, the body speed of the legged robot may be divided into an instruction direction speed and a non-instruction direction speed based on the movement direction instruction. It is hoped that the legged robot can move in the expected direction indicated by the instruction, and none of movement of the legged robot in the non-instruction direction is encouraged. Therefore, when the instruction direction speed in the body speed exceeds an expected speed range (is less than the expected lower speed limit), it indicates that a movement speed of the legged robot in the expected movement direction does not meet a requirement (is excessively slow), and that a second reward value corresponding to an action of the legged robot at a current moment is a reverse reward (a penalty), to penalize excessively slow movement of the legged robot in the expected direction.

In one embodiment, the second reward value is determined based on the body speed, the movement direction, and the expected lower speed limit, and the second speed reward value is less than the default reward value.

In some embodiments, a third speed reward value is determined based on the body speed, the movement direction, and the expected lower speed limit when the body speed is greater than the expected upper speed limit; the third speed reward value is used as the in-instruction speed reward, and the third speed reward value is less than the default reward value; and the out-of-instruction speed reward is determined based on the body speed and the movement direction, the out-of-instruction speed reward being in a negative correlation with the body speed.

In one embodiment, similar to the foregoing embodiment, when the instruction direction speed in the body speed exceeds an expected speed range (is greater than the expected upper speed limit), it indicates that a movement speed of the legged robot in the expected movement direction does not meet a requirement (is excessively fast), and that a third reward value corresponding to an action of the legged robot at a current moment is a reverse reward (a penalty), to penalize excessively fast movement of the legged robot in the expected direction.

In one embodiment, the third reward value is determined based on the body speed, the movement direction, and the expected upper speed limit, and the third speed reward value is less than the default reward value.

In a possible application scenario, the first reward value is 1, the second reward value and the third reward value may be calculated by using the following formula: In the formula: rᵥ represents the in-instruction speed reward, and the expected speed range is (vₗ, vₕ), and vₗ is the expected lower speed limit, vₕ is the expected upper speed limit, cₜ=[cos θ, sin θ, 0], θ∈[0,2π] is the movement direction instruction, θ is an angle between the instruction movement direction and a current movement direction of the legged robot, and

$${v}_{t}^{T} {c}_{t}$$

represents the sub-speed in the instruction direction (the instruction direction speed) in the body speed of the legged robot.

$${r}_{v} = \{ \begin{matrix}1 , & {v}_{l} \leq {v}_{t}^{T} {c}_{t} \leq {v}_{h} \\ {{e}^{- 2 ( {v}_{t}^{T} {c}_{t} - {v}_{h} )}}^{2} , & {v}_{t} > {v}_{h} \\ {e}^{- 2 {( {v}_{t}^{T} {c}_{t} - {v}_{l} )}^{2}} , & {v}_{t} < {v}_{l}\end{matrix}$$

In one embodiment, none of movement of the legged robot in the non-instruction direction is encouraged, and the non-instruction direction speed in the body speed represents movement of the legged robot in an out-of-instruction direction. Therefore, all out-of-instruction rewards corresponding to actions of the legged robot in the non-instruction direction at a current moment are reverse rewards (penalties), to penalize movement of the legged robot in the out-of-instruction direction. Moreover, farther movement of the legged robot (that is, a larger speed in the non-instruction direction) indicates a larger penalty fed back by the legged robot to the deep neural network. That is, the non-instruction direction speed is in a negative correlation with the out-of-instruction speed reward. Because the in the non-instruction direction speed is a sub-speed of the body speed in the non-instruction direction, the out-of-instruction speed reward determined by the legged robot based on the body speed and the movement direction is also in a negative correlation with the sub-speed of the body speed in the movement direction.

In a possible application scenario, the out-of-instruction speed reward may be calculated by using the following formula, where rᵥₒ represents the out-of-instruction speed reward, the movement direction instruction is expressed as cₜ=[cos θ, sin θ, 0], θ∈[0,2π], θ is an angle between the instruction movement direction and a current movement direction of the legged robot, and

$${v}_{t}^{T} {v}_{t} - {v}_{t}^{T} {c}_{t}$$

represents the sub-speed in the body speed of the legged robot in the non-instruction direction (the non-instruction direction speed).

$${r}_{v o} = {e}^{- 1.5 {( {v}_{t}^{T} {v}_{t} - {v}_{t}^{T} {c}_{t} )}^{2}}$$

2. The motion reward includes an energy reward, and the energy reward is configured for encouraging the legged robot to reduce energy consumption during motion. A process of determining the motion reward based on the motion state includes the following operations:
obtaining joint torque and a joint angular velocity of the legged robot;
determining a joint motion power based on the joint torque and the joint angular velocity; and
determining the energy reward based on the joint motion power, the energy reward being in a negative correlation with the joint motion power.

In one embodiment, the energy consumption of the legged robot is in a positive correlation with the joint motion power of the legged robot, and the joint motion power is related to the torque and the joint angular velocity of each joint of the legged robot. It is hoped that the legged robot can reduce energy consumption during stable motion. Therefore, the energy reward is a reverse reward (a penalty). That is, a larger quantity of energy consumed by the legged robot indicates a larger penalty value fed back to the deep neural network. Therefore, the energy reward is in a negative correlation with the joint motion power.

In a possible application scenario, the energy reward may be calculated by using the following formula, where rₜₐᵤ represents the energy reward, τₜ represents the torque of each joint, and q_{v,t} represents the joint angular velocity of each joint.

$${r}_{tau} = - {τ}_{t}^{T} {q}_{v , t}$$

3. The motion reward includes a foot terrain reward, and the foot terrain reward is configured for encouraging the legged robot to avoid a risky terrain. A process of determining the motion reward based on the motion state may include the following operations:

In one embodiment, there are two states of a leg of the legged robot during motion. One state is a leg lift state (swing), and the other state is a bottom-touch state (stance). The legged robot obtains foot terrain heights. A difference between a maximum value and a minimum value among the foot terrain heights corresponding to the leg is determined as a terrain height difference.

In some embodiments, when the leg state of the legged robot is the leg lift state, or the leg state of the legged robot is the bottom-touch state and the terrain height difference is greater than a risky terrain height threshold, a first value is determined as the foot terrain reward. A foot terrain reward is calculated once for each leg of the legged robot.

When the leg of the legged robot is in the leg lift state, it indicates that the leg does not step into a risky terrain (for example, a terrain gap) temporarily. Therefore, the first value is determined as the foot terrain reward, and the first value is a default value set by the legged robot.

When the leg of the legged robot is in the bottom-touch state, if the terrain height difference is greater than the risky terrain height threshold in this case, it indicates that a terrain into which the leg steps into is a safe terrain, and the legged robot also determines the first value as the foot terrain reward to be fed back to the deep neural network, thereby characterizing encouraging an action of the leg of the legged robot stepping into the safe terrain by the leg of the legged robot.

In one embodiment, when the leg state of the legged robot is in the bottom-touch state and the terrain height difference is less than the risky terrain height threshold, a second value is determined as the foot terrain reward, and the second value is less than the first value.

When the leg of the legged robot is in the bottom-touch state and the terrain height difference is less than the risky terrain height threshold, it indicates that the leg already steps into a risky terrain (for example, a terrain gap). Therefore, in the foot terrain reward fed back by the legged robot to the deep neural network, the foot terrain reward corresponding to the second value is less than the foot terrain reward corresponding to the first value, thereby characterizing discouraging an action of stepping into the risky terrain by the leg of the legged robot.

In one embodiment, the foot terrain reward may be set according to the following formula, where r_{terrain,i} represents a foot terrain reward corresponding to an i^{th} leg (fᵢ) of the legged robot, max(zᵢⱼ)−min(zᵢⱼ) represents the difference (the terrain height difference) between the maximum value and the minimum value among the corresponding foot terrain heights corresponding to the i^{th} leg (fᵢ) of the legged robot, and Hₜₕᵣₑ represents the risky terrain height threshold.

$${r}_{terrain , i} = \{ \begin{matrix}0 , & {f}_{i} is swing or max ( {z}_{ij} ) - min ( {z}_{ij} ) > {H}_{thre} \\ - 1 , & elsewise\end{matrix}$$

4. The motion reward includes a leg-lifting height reward, and the leg-lifting height reward is configured for encouraging the legged robot to lower a leg-lifting height. A process of determining the motion reward based on the motion state may include the following operations:

In one embodiment, a leg-lifting height reward is calculated for each leg of the legged robot.

In some embodiments, the legged robot first obtains a leg-lifting height of each leg, a foot terrain height corresponding to each leg, and a sample leg-lifting height residual in the sample predicted residual, and then determines a difference between a maximum value and a minimum value among foot terrain heights corresponding to a leg as a terrain height difference corresponding to the leg. The leg-lifting height difference of the leg may be determined based on the leg-lifting height, the sample leg-lifting height residual, the terrain height difference, and a leg-lifting height threshold.

When the leg-lifting height difference is greater than 0, the legged robot determines the leg-lifting height reward based on the leg-lifting height difference. The leg-lifting height reward is in a negative correlation with the leg-lifting height difference. In other words, a larger leg-lifting height difference indicates a smaller leg-lifting height reward (because an excessively high leg lift causes increased power consumption).

In one embodiment, if a leg-lifting height difference of a leg of the legged robot is less than or equal to 0, the legged robot determines a leg-lifting height reward of the leg as 0.

In one embodiment, the leg-lifting height reward may be set according to the following formula, where r_{height,i} represents a leg-lifting height reward corresponding to an i^{th} leg (fᵢ) of the legged robot, H represents a reference leg-lifting height of the legged robot, δh is the sample leg-lifting height residual, ΔH is the difference (the terrain height difference) between the maximum value and the minimum value among terrain heights, and Fₜₕᵣₑ represents the leg-lifting height threshold.

$${r}_{height , i} = - max ( H + δ h - Δ H - {F}_{thre} , 0 )$$

5. The motion reward includes a smoothness reward, and the smoothness reward is configured for encouraging the legged robot to have a smooth gait. A process of determining the motion reward based on the motion state may include the following operations:

In one embodiment, the legged robot determines a joint angle difference corresponding to joints at adjacent moments; and determines the smoothness reward based on the joint angle difference, the smoothness reward being in a negative correlation with the joint angle difference. If the joint angle difference corresponding to the joints of the legged robot at the adjacent moments is relatively small, it indicates that a motion amplitude of the legged robot is relatively small, that is, an action is smoother.

In one embodiment, the smooth reward may be set according to the following formula, where rₛₘₒₒₜₕ represents the smoothness reward of the legged robot, qₜ represents a joint angle of the legged robot at a current moment, and qₜ₋₁ represents a joint angle of the legged robot at a previous moment.

$${r}_{smooth} = {e}^{- 0.5 {( {q}_{t} - {q}_{t - 1} )}^{T} ( {q}_{t} - {q}_{t - 1} )}$$

Operation 606: Train the deep neural network based on the motion reward.

In one embodiment, the deep neural network is trained based on the motion reward in a reinforcement learning manner.

In some embodiments, the legged robot trains the neural network in the reinforcement learning manner based on at least one of the in-instruction speed reward, the out-of-instruction speed reward, the energy reward, the foot terrain reward, the leg-lifting height reward, and the smoothness reward. The legged robot determines reward values of the foregoing five types of rewards based on a current motion state, and feeds back the reward values to the deep neural network, so that the deep neural network optimizes a network parameter based on a policy gradient algorithm, for example, a proximal policy optimization (PPO) algorithm, to output a more accurate predicted residual.

In some embodiments, the legged robot may train the deep neural network in the reinforcement learning manner based on the foregoing five types of motion rewards (the in-instruction speed reward, the out-of-instruction speed reward, the energy reward, the foot terrain reward, the leg-lifting height reward, and the smoothness reward).

The legged robot may alternatively train the deep neural network in the reinforcement learning manner based on some types of motion rewards. For example, the legged robot trains the neural network in the reinforcement learning manner based on the in-instruction speed reward, the out-of-instruction speed reward, and the foot terrain reward. The legged robot determines reward values respectively corresponding to the in-instruction speed reward, the out-of-instruction speed reward, and the foot terrain reward based on a current motion state, and feeds back the reward values to the deep neural network, so that the deep neural network optimizes a network parameter based on the policy gradient algorithm, for example, the PPO algorithm, to output a more accurate predicted residual.

In one embodiment, when the deep neural network is trained based on at least two types of motion rewards, reward weights may be set for different types of motion rewards based on a motion requirement of the legged robot, and weighting calculation is performed on the at least two types of motion rewards based on the reward weights, to train the deep neural network based on a weighted motion reward.

For example, a high weight may be set for the foot terrain reward, thereby improving operational safety of the legged robot in a complex environment. A high weight may be set for a capability reward, to reduce operation power consumption of the legged robot. The specific reward weight setting manner is not limited in embodiments of the present disclosure.

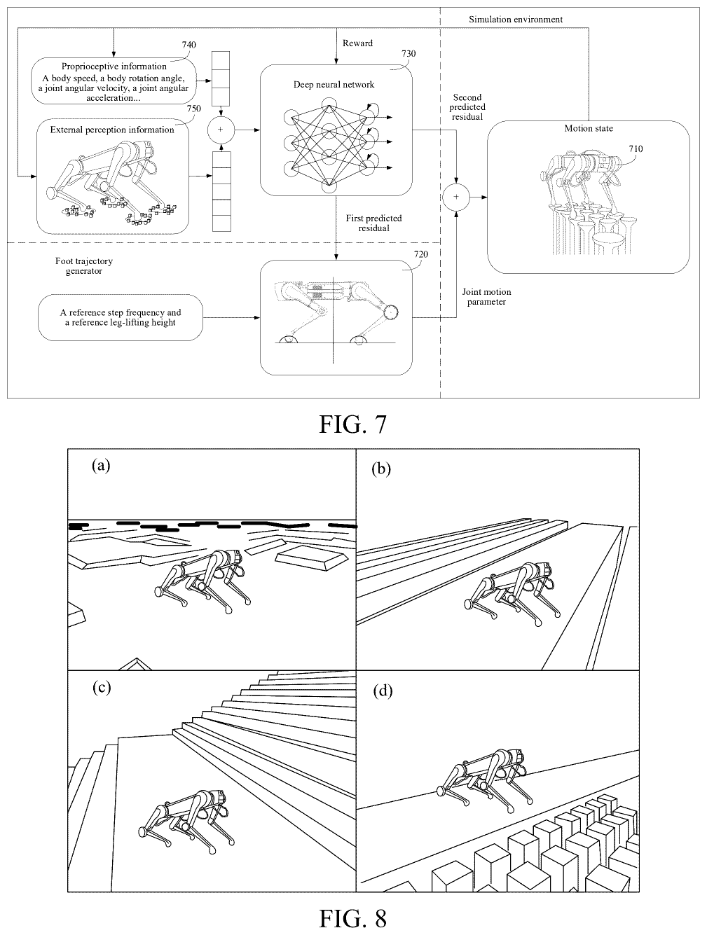

Refer to FIG. 7. FIG. 7 is a schematic diagram of a legged robot control process according to the foregoing embodiment. FIG. 7 includes a legged robot 710, a foot trajectory controller 720, and a deep neural network 730. In the figure, an example in which the legged robot is a quadruped robot is used. The legged robot 710 obtains proprioceptive information 740 and external perception information 750, and inputs, into the deep neural network 730, the proprioceptive information 740 and the external perception information 750 on which vectorized feature processing is performed. The deep neural network 730 outputs a first predicted residual and a second predicted residual. The first predicted residual is configured for correcting a trajectory generation parameter of the foot trajectory generator 720 of the legged robot 710, and the second predicted residual is configured for correcting a joint motion parameter. The trajectory generation parameter corresponding to the foot trajectory generator 720 may include a reference step frequency and a reference leg-lifting height. The foot trajectory generator 720 whose parameter is adjusted outputs a joint motion parameter at a next moment. The legged robot 710 corrects the joint motion parameter based on the second predicted residual. The legged robot 710 controls a motion state of the legged robot based on the joint motion parameter. The legged robot 710 feeds back a reward to the deep neural network 730 based on the motion state, so that the deep neural network 730 is trained based on the reward in a reinforcement learning manner.

In conclusion, in embodiments of the present disclosure, the legged robot obtains sample proprioceptive information and sample external perception information, so that the deep neural network predicts the motion state of the legged robot based on the sample proprioceptive information and the sample external perception information, and outputs a sample predicted residual. In this way, the legged robot performs a parameter adjustment on the foot trajectory generator based on the sample predicted residual, and controls the motion state by using a sample joint motion parameter outputted by the foot trajectory generator. The legged robot determines a motion reward based on the motion state, and trains the deep neural network in the reinforcement learning manner by using the motion reward, so that a trained deep neural network can output a more accurate predicted residual.

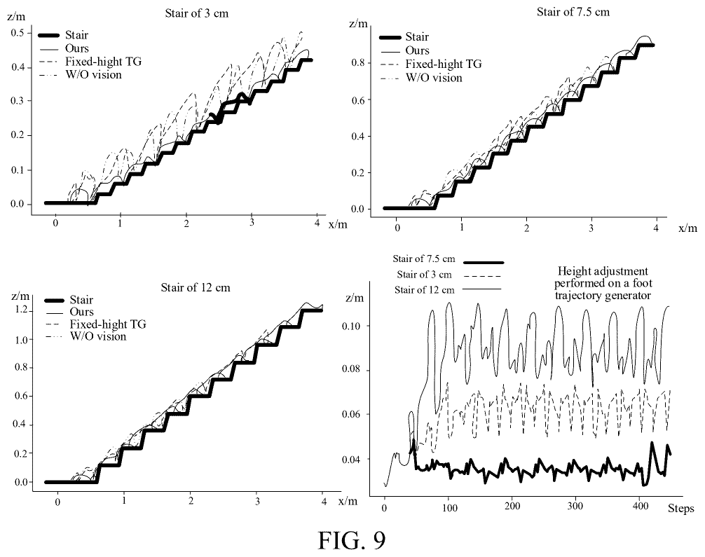

In a possible application scenario, FIG. 8 is a schematic diagram of a simulation environment according to an exemplary embodiment of the present disclosure. A simulation experiment is performed on a legged robot based on a legged robot control method, to obtain a simulation result, to check whether the legged robot using the control method can adapt to various complex environments during motion, and determine, through a comparison with a simulation result of a legged robot not using the control method in the simulation environment, whether flexibility and stability of the legged robot using the control method during motion in the complex environment are improved.

In the figure, (a) in FIG. 8 is a simulation environment of a block terrain, (b) in FIG. 8 is a simulation environment of a stone stepping terrain, (c) in FIG. 8 is a simulation environment of a stair terrain, and (d) in FIG. 8 is a simulation environment of a quincuncial pile terrain.

The legged robot walks in the foregoing four different simulation environments by using three control solutions, to obtain corresponding simulation results for a comparison. A first control solution is a control solution provided in embodiments of the present disclosure. The legged robot performs motion control by using the control method in embodiments of the present disclosure, and advances in the simulation environments of the block terrain, the stair terrain, the stone stepping terrain, and the quincuncial pile terrain. A distance by which the legged robot advances in each simulation environment is used as a simulation result corresponding to each simulation environment. A second control solution is a fixed-height TG solution. A legged robot may obtain both proprioceptive information and external perception information. However, a trajectory generation parameter of a foot trajectory generator (TG) of the legged robot is fixed, and is not adjusted based on a motion state of the legged robot. Correspondingly, the legged robot using the second control solution also advances in the simulation environments of the block terrain, the stair terrain, the stone stepping terrain, and the quincuncial pile terrain, and a distance by which the legged robot advances in each simulation environment is used as a simulation result corresponding to each simulation environment. A third control solution is a non-perception control solution. A legged robot may obtain only proprioceptive information instead of external perception information. A trajectory generation parameter of a foot trajectory generator (TG) of the legged robot may be adjusted based on a motion state of the legged robot. Correspondingly, the legged robot using the third control solution also advances in the simulation environments of the block terrain, the stair terrain, the stone stepping terrain, and the quincuncial pile terrain, and a distance by which the legged robot advances in each simulation environment is used as a simulation result corresponding to each simulation environment.

For external perception information, in the simulation experiments, both the legged robot in the solution of the present disclosure and the legged robot in the fixed-height TG solution may obtain the external perception information. The external perception information is a terrain height map generated by the legged robot. Each leg of the legged robot is used as a circle center, and terrain heights are sampled by using circumferences with radiuses of 0 cm, 3 cm, 6 cm, and 10 cm. Heights of 1, 6, 8, and 10 points are sampled in turn from the circumferences with radiuses of 0 cm, 3 cm, 6 cm, and 10 cm as terrain sampling point heights. The legged robot generates a terrain height map based on the terrain sampling point heights and uses the terrain height map as the external perception information.

For proprioceptive information, in the simulation experiments, the legged robots in the three solutions may obtain internal perception information. The internal perception information includes a movement direction instruction. To determine whether the legged robots in the three solutions are capable of walking in any direction in the different simulation environments, 6 different direction instructions are randomly extracted from [0, π/4, −π/4, −π, −5π/4, −3π/4] as movement direction instructions, where a direction 0 represents walking forward, and −π represents walking backward. Movement direction instructions are randomly extracted three times in each solution, and three random experiments are performed based on the extracted movement direction instructions. An average value and a standard deviation of maximum advancing distances of the legged robots in the three random experiments are calculated, and the average value and the standard deviation are used as a simulation result.

Due to a limit of a map size of the simulation environment, the maximum advancing distance of the legged robots is 5 m in an ideal case. A final result is shown in Table 1.

TABLE 1

| | Solution of the | | Non-perception |
|---|---|---|---|
| | present | Fixed TG | solution |
| | disclosure | solution | (Average |
| | (Average | (Average | distance/meter ± |
| | distance/meter ± | distance/meter ± | distance |
| | distance variance) | distance variance) | variance) |
| Block terrain | 4.983 ± 0.038 | 4.911 ± 0.140 | 4.948 ± 0.104 |
| Stair terrain | 4.951 ± 0.114 | 4.859 ± 0.383 | 4.960 ± 0.092 |
| Stone stepping | 4.954 ± 0.070 | 1.782 ± 1.054 | 1.539 ± 0.856 |
| terrain | | | |
| Quincuncial | 4.930 ± 0.099 | 1.924 ± 1.132 | 1.906 ± 0.925 |
| pile terrain | | | |

It can be known from Table 1 that, in each simulation environment, the legged robot in the solution of the present disclosure has the best comprehensive performance. In the two terrain environments, namely, the block terrain and the stair terrain, both advancing distances exceed 4.9 m. In addition, in the two complex terrain environments with terrain gaps, namely, the stone stepping terrain and the quincuncial pile terrain, the legged robot may also advance more than 4.9 m. In addition, variances corresponding to the advancing distances in the four scenarios are relatively small, indicating that the legged robot may advance relatively stably in each instruction direction. However, compared with the solution of the present disclosure, in the fixed-height TG solution and the non-perception solution, flexibility of the legged robots in the two complex terrain environments with terrain gaps, namely, the stone stepping terrain and the quincuncial pile terrain is not good enough, and advancing distances are relatively small (less than 2 m). In addition, variances corresponding to the advancing distances are relatively large, indicating that advancing situations of the legged robots in the two solutions in various instruction directions are quite different, and advancing stability is relatively poor. It can be known that obtaining the external perception information and adjusting the parameter of the foot trajectory generator during motion of the legged robot have a relatively great impact on motion control of the legged robot in complex environments. In this solution of the present disclosure, the external perception information is obtained while obtaining the proprioceptive information, and the parameter of the foot trajectory generator is adjusted based on the motion state of the legged robot, so that the legged robot can avoid a risky terrain and advance in an expected direction.

In a possible application scenario, as shown in FIG. 9, FIG. 9 is a schematic diagram of comparing leg-lifting heights according to an exemplary embodiment of the present disclosure. A preferred legged robot control method may support the legged robot in adjusting a leg-lifting height based on a terrain height, thereby reducing energy consumption of the legged robot, rather than lifting a leg as high as possible in all terrains. To evaluate whether the legged robot using the control method of the present disclosure may adjust the leg-lifting height based on the terrain height, to reduce energy consumption, a foot trajectory generated by the legged robot using the solution of the present disclosure is compared with a foot trajectory generated by the legged robot using a related technology solution. Tests are carried out in different terrain environments (a stair terrain), and comparison results are shown in FIG. 9.

In FIG. 9, the legged robot is tested in three terrain environments that are respectively: a stair terrain with a step height of 3 cm, a stair terrain with a step height of 7.5 cm, and a stair terrain with a step height of 12 cm. Foot trajectories generated by the legged robots in three control solutions of the legged robot are compared in the terrain environments. A first control solution is a control solution (ours) provided by embodiments of the present disclosure, a second control solution is a fixed-height TG solution (fixed-height TG), and a third control solution is a no-perception solution (w/o vision, without vision).

It can be seen from FIG. 9 that, the legged robot in the solution of the present disclosure may adjust a leg-lifting height based on different stair step heights. However, in another solution, when the legged robot faces a stair terrain with relatively low step heights (3 cm and 7.5 cm), a leg-lifting height of the legged robot is clearly higher than the leg-lifting height of the legged robot in this solution. In addition, the fourth figure in FIG. 9 draws a case in which a leg-lifting height parameter (H+δh) outputted by a foot trajectory generator of the legged robot in the solution of the present disclosure is adjusted by using a deep neural network in the stair terrain with different step heights. It can be seen from the figure that, the foot trajectory generator may adjust the outputted leg-lifting height parameter based on the terrain heights. Particularly, for a stair terrain with a height of 3 cm, the leg-lifting height parameter outputted by the foot trajectory generator may enable the legged robot to reduce a leg-lifting height to approximately 3 cm. These results indicate that the legged robot using the control method of the present disclosure may adjust the leg-lifting height based on the terrain height, thereby effectively reducing energy consumption.

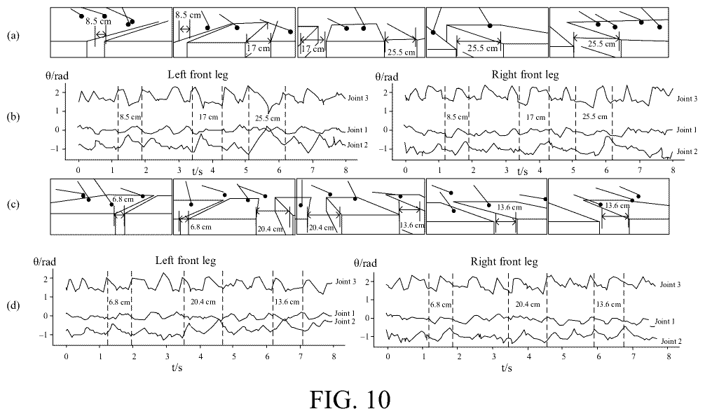

In a possible application scenario, as shown in FIG. 10, FIG. 10 is a schematic diagram of joint angle changes according to an exemplary embodiment of the present disclosure. To evaluate whether a legged robot using a control method of the present disclosure can avoid a risky terrain in a complex environment, to improve flexibility and stability of the legged robot during motion in the complex environment, the legged robot using a solution of the present disclosure is tested in two terrain environments, and joint angle changes of the legged robot in the different terrain environments are observed. The joint angle changes of the legged robot in the two terrain environments are shown in FIG. 10.

The two terrain environments configured for testing are both stone stepping terrains, but terrain gaps in the two terrain environments are set to be different. In a first terrain environment (a), widths of the terrain gaps are set to 8.5 cm, 17.0 cm, and 25.5 cm, and a joint change (b) of the legged robot is obtained through testing. In a second terrain environment (c), widths of the terrain gaps are set to 6.8 cm, 20.4 cm, and 13.6 cm, and a joint change (d) of the legged robot is obtained through testing. With respect to joint changes of the legged robot, joint angle changes (a joint angle θ/rad) corresponding to three joints (a joint 1, a joint 2, and a joint 3) of a left front leg of the legged robot and joint angle changes (a joint angle θ/rad) corresponding to three joints of a right front leg of the legged robot are tested in the two terrain environments.

It can be seen from FIG. 10 that the legged robot using the control method in the present disclosure may safely span gaps with different widths. In addition, in the two terrain environments, an angle between a second joint of the left front leg and a second joint of the right front leg may be adjusted based on different terrain gap widths. As the terrain gap width increases, a joint angle change increases accordingly.

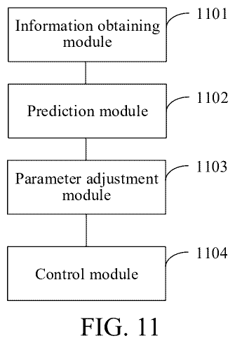

FIG. 11 is a block diagram of a structure of a legged robot control apparatus according to an exemplary embodiment of the present disclosure. The apparatus includes:
an information obtaining module 1101, configured to obtain proprioceptive information and external perception information, the proprioceptive information being configured for characterizing a motion state of a body of a legged robot, and the external perception information being configured for characterizing environment information around the legged robot;
a prediction module 1102, configured to input the proprioceptive information and the external perception information into a deep neural network, to obtain a first predicted residual outputted by the deep neural network, the first predicted residual being configured for correcting a trajectory generation parameter of a foot trajectory generator;
a parameter adjustment module 1103, configured to adjust the trajectory generation parameter of the foot trajectory generator based on the first predicted residual; and
a control module 1104, configured to control a motion state of the legged robot based on a joint motion parameter outputted by the foot trajectory generator whose parameter is adjusted.

In one embodiment, the first predicted residual includes a step frequency residual and a leg-lifting height residual, and the trajectory generation parameter of the foot trajectory generator includes a step frequency parameter and a leg-lifting height parameter; and the parameter adjustment module 1103 is configured to:
correct a reference step frequency based on the step frequency residual, to obtain an adjusted step frequency parameter; and
correct a reference leg-lifting height based on the leg-lifting height residual, to obtain an adjusted leg-lifting height parameter.

In one embodiment, an output of the deep neural network further includes a second predicted residual, and the second predicted residual is configured for correcting the joint motion parameter outputted by the foot trajectory generator; and the control module 1104 is configured to:
obtain the joint motion parameter outputted by the foot trajectory generator whose parameter is adjusted;
correct the joint motion parameter based on the second predicted residual; and
control the motion state of the legged robot based on a corrected joint motion parameter.

In one embodiment, the deep neural network is an LSTM network, and the information obtaining module 1101 is configured to:
use a received movement direction instruction, a historical motion parameter of the legged robot, and a historical predicted residual as the proprioceptive information, the historical predicted residual including a historical first predicted residual and a historical second predicted residual that are outputted by the deep neural network.

In one embodiment, the information obtaining module 1101 is configured to:
obtain a first terrain height map around a foot of the legged robot; and use the first terrain height map as the external perception information;
or
obtain a second terrain height map of an area of a specific shape below a reference location of the legged robot; and use the second terrain height map as the external perception information.

In one embodiment, the information obtaining module 1101 is configured to:
sample ground heights based on at least two sampling radiuses by using the foot of the legged robot as a center, to obtain at least two ground sampling point heights; and
generate the first terrain height map based on a difference between a height of the foot and the ground sampling point heights.

In one embodiment, the apparatus further includes: a network training module, configured to:
obtain sample proprioceptive information and sample external perception information;
input the sample proprioceptive information and the sample external perception information into the deep neural network, to obtain a sample predicted residual outputted by the deep neural network;
perform a parameter adjustment on the foot trajectory generator based on the sample predicted residual;
control the motion state of the legged robot based on a sample joint motion parameter outputted by the foot trajectory generator whose parameter is adjusted;
determine a motion reward based on the motion state; and
train the deep neural network based on the motion reward.

In one embodiment, the motion reward includes at least one of an in-instruction speed reward and an out-of-instruction speed reward, and the in-instruction speed reward and the out-of-instruction speed reward are configured for encouraging the legged robot to move along an expected direction and at an expected speed; and the network training module is configured to:
obtain a body speed of the legged robot and a movement direction indicated by the movement direction instruction;
determine a default reward value as a first speed reward value when the body speed is greater than an expected lower speed limit and less than an expected upper speed limit; and use the first speed reward value as the in-instruction speed reward;
or
determine a second speed reward value based on the body speed, the movement direction, and an expected lower speed limit when the body speed is less than the expected lower speed limit; and use the second speed reward value as the in-instruction speed reward, the second speed reward value being less than a default reward value;
or
determine a third speed reward value based on the body speed, the movement direction, and an expected upper speed limit when the body speed is greater than the expected upper speed limit; and use the third speed reward value as the in-instruction speed reward, the third speed reward value being less than a default reward value; and
determine the out-of-instruction speed reward based on the body speed and the movement direction, the out-of-instruction speed reward being in a negative correlation with a sub-speed of the body speed outside the movement direction.

In one embodiment, the motion reward includes an energy reward, and the energy reward is configured for encouraging the legged robot to reduce energy consumption during motion; and the network training module is configured to:
the determining a motion reward based on the motion state comprises:
obtain joint torque and a joint angular velocity of the legged robot;
determine a joint motion power based on the joint torque and the joint angular velocity; and
determine the energy reward based on the joint motion power, the energy reward being in a negative correlation with the joint motion power.

In one embodiment, the motion reward includes a foot terrain reward, and the foot terrain reward is configured for encouraging the legged robot to avoid a risky terrain; and the network training module is configured to:
obtain a foot terrain height of the legged robot;
determine a difference between a maximum value and a minimum value in the foot terrain height as a terrain height difference; and
determine a first value as the foot terrain reward when the legged robot is in a leg lift state or a bottom-touch state and the terrain height difference is greater than a risky terrain height threshold;
or
determine a second value as the foot terrain reward when the legged robot is in a bottom-touch state and the terrain height difference is less than a risky terrain height threshold.

In one embodiment, the motion reward includes a leg-lifting height reward, and the leg-lifting height reward is configured for encouraging the legged robot to lower a leg-lifting height; and the network training module is configured to:
obtain a leg-lifting height of the legged robot, the foot terrain height, and a sample leg-lifting height residual in the sample predicted residual;
determine a difference between a maximum value and a minimum value in the foot terrain height as a terrain height difference;
determine a leg-lifting height difference based on the leg-lifting height, the sample leg-lifting height residual, the terrain height difference, and a leg-lifting height threshold;
determine the leg-lifting height reward based on the leg-lifting height difference when the leg-lifting height difference is greater than 0, the leg-lifting height reward being in a negative correlation with the leg-lifting height difference; and
when the leg-lifting height difference is less than or equal to 0, determine that the leg-lifting height reward is 0.

In one embodiment, the motion reward includes a smoothness reward, and the smoothness reward is configured for encouraging the legged robot to have a smooth gait; and the network training module is configured to:
determine a joint angle difference of the legged robot at adjacent moments; and
determine the smoothness reward based on the joint angle difference, the smoothness reward being in a negative correlation with the joint angle difference.

In this manner, in embodiments of the present disclosure, a parameterized foot trajectory generator is introduced. The foot trajectory generator supports adjusting the trajectory generation parameter by using the deep neural network. When the parameter adjustment is performed on the foot trajectory generator by using the deep neural network, the proprioceptive information characterizing the motion state of the legged robot itself and the external perception information characterizing a surrounding environment of the legged robot are combined. Therefore, compared with a foot trajectory generator with a fixed parameter, the foot trajectory generator supporting parameterization can generate a foot trajectory better conforming to a current environment. Further, the legged robot is controlled based on the joint motion parameter outputted by the foot trajectory generator whose parameter is adjusted, so that flexibility and stability of the legged robot during motion in a complex environment can be improved.

The apparatus provided in the foregoing embodiment is illustrated only with an example of division of the foregoing function modules. In practical applications, the foregoing functions may be allocated to and completed by different function modules according to requirements. That is, the internal structure of the apparatus is divided into different function modules to complete all or some of the functions described above. In addition, the apparatuses provided in the foregoing embodiments and the method embodiments fall within the same conception. For details of a specific implementation process, refer to the method embodiments. Details are not described herein again.

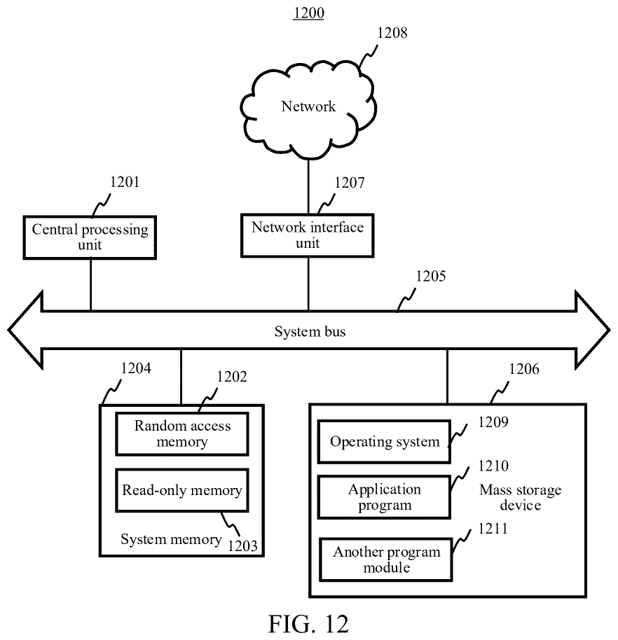

FIG. 12 is a block diagram of a structure of a legged robot 1200 according to an exemplary embodiment of the present disclosure. The legged robot may be implemented as a server in the foregoing solutions of the present disclosure. The legged robot 1200 includes a central processing unit (CPU) 1201, a system memory 1204 including a random access memory (RAM) 1202 and a read-only memory (ROM) 1203, and a system bus 1205 connecting the system memory 1204 and the central processing unit 1201. The legged robot 1200 further includes a mass storage device 1206 configured to store an operating system 1209, an application program 1210, and another program module 1211.

The mass storage device 1206 is connected to the central processing unit 1201 by using a mass storage controller (not shown) connected to the system bus 1205. The mass storage device 1206 and a computer-readable medium associated with the mass storage device provide non-volatile storage for the legged robot 1200. In other words, the mass storage device 1206 may include a computer-readable storage medium (not shown) such as a hard disk or a compact disc read-only memory (CD-ROM) drive.

Without loss of generality, the computer-readable medium may include a computer storage medium and a communication medium. The computer storage medium includes volatile and non-volatile media, and removable and non-removable media implemented by using any method or technology configured for storing information such as computer-readable instructions, data structures, program modules, or other data. The computer storage medium includes a RAM, a ROM, an erasable programmable read-only memory (EPROM), an electrically erasable programmable read-only memory (EEPROM), a flash memory or another solid-state storage device, a CD-ROM, a digital versatile disc (DVD) or another optical storage, a cartridge, a magnetic tape, a magnetic disk memory, or another magnetic storage device. Certainly, a person skilled in the art may learn that the computer storage medium is not limited to the foregoing several types. The system memory 1204 and the mass storage device 1206 may be collectively referred to as a memory.

According to the embodiments of the present disclosure, the legged robot 1200 may further be connected, through a network such as the Internet, to a remote computer on the network and run. That is, the legged robot 1200 may be connected to a network 1208 by using a network interface unit 1207 connected to the system bus 1205, or may be connected to another type of network or a remote computer system (not shown) by using the network interface unit 1207.

The memory further includes at least one segment of computer program, the at least one segment of computer program is stored in the memory, and the central processing unit 1201 implements, by executing the at least one segment of program, the legged robot control method shown in the foregoing embodiments.

An embodiment of the present disclosure further provides a legged robot, the legged robot including a processor and a memory, the memory having at least one computer instruction stored therein, and the at least one computer instruction being loaded and executed by the processor, to implement the legged robot control method according to the foregoing method embodiments.

An embodiment of the present disclosure further provides a computer-readable storage medium, the storage medium having at least one computer instruction stored therein, and the at least one computer instruction being loaded and executed by a processor, to implement the legged robot control method according to the foregoing method embodiments.

An embodiment of the present disclosure further provides a computer program product, including computer instructions, the computer instructions being stored in a computer-readable storage medium; and a processor of a legged robot reading and executing the computer instructions from the computer-readable storage medium, so that the legged robot implements the legged robot control method according to the foregoing method embodiments.

An embodiment of the present disclosure further provides a chip, the chip including a programmable logic circuit or a program, and a device having the chip installed thereon being configured to implement the foregoing legged robot control method.

In a specific implementation of the present disclosure, for related data in user data processing related to user identities or characteristics such as data involved, historical data, and portraits, when the embodiments of the present disclosure are applied to a specific product or technology, it is necessary to obtain the user's permission or consent, and the collection, usage, and processing of related data need to comply with relevant laws, regulations and standards of relevant countries and regions.

As such, a parameterized foot trajectory generator is introduced according to various embodiments of the present disclosure. The foot trajectory generator supports adjusting the trajectory generation parameter by using the deep neural network. When the parameter adjustment is performed on the foot trajectory generator by using the deep neural network, proprioceptive information characterizing a motion state of self of the legged robot and the external perception information characterizing a surrounding environment of the legged robot are combined. Therefore, compared with a foot trajectory generator with a fixed parameter, the foot trajectory generator supporting parameterization can generate a foot trajectory better conforming to a current environment. Further, the legged robot is controlled based on the joint motion parameter outputted by the foot trajectory generator whose parameter is adjusted, so that flexibility and stability of the legged robot during motion in a complex environment can be improved.

A person of ordinary skill in the art may understand that all or some of the steps of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely exemplary embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A legged robot control method, performed by a legged robot, and the method comprising:
obtaining proprioceptive information and external perception information, the proprioceptive information being configured for characterizing a motion state of the legged robot, and the external perception information being configured for characterizing environment information around the legged robot;
inputting the proprioceptive information and the external perception information into a deep neural network, to obtain a first predicted residual outputted by the deep neural network, the first predicted residual being configured for correcting a trajectory generation parameter of a foot trajectory generator;
adjusting the trajectory generation parameter of the foot trajectory generator based on the first predicted residual; and
controlling the motion state of the legged robot based on a joint motion parameter outputted by the foot trajectory generator after the trajectory generation parameter is adjusted.

2. The method according to claim 1, wherein the first predicted residual comprises a step frequency residual and a leg-lifting height residual, and the trajectory generation parameter of the foot trajectory generator comprises a step frequency parameter and a leg-lifting height parameter; and
adjusting the trajectory generation parameter of the foot trajectory generator based on the first predicted residual comprises:
correcting a reference step frequency based on the step frequency residual, to obtain an adjusted step frequency parameter; and
correcting a reference leg-lifting height based on the leg-lifting height residual, to obtain an adjusted leg-lifting height parameter.

3. The method according to claim 2, wherein an output of the deep neural network further comprises a second predicted residual, and the second predicted residual is configured for correcting the joint motion parameter outputted by the foot trajectory generator; and
controlling the motion state of the legged robot based on the joint motion parameter outputted by the foot trajectory generator comprises:
obtaining the joint motion parameter outputted by the foot trajectory generator after the trajectory generation parameter is adjusted;
correcting the joint motion parameter based on the second predicted residual; and
controlling the motion state of the legged robot based on the corrected joint motion parameter.

4. The method according to claim 3, wherein the deep neural network is a long short-term memory (LSTM) network, and obtaining the proprioceptive information comprises:
using a movement direction instruction, a historical motion parameter of the legged robot, and a historical predicted residual as the proprioceptive information, the historical predicted residual comprising a historical first predicted residual and a historical second predicted residual that are outputted by the deep neural network.

5. The method according to claim 1, wherein obtaining the external perception information comprises:
obtaining a first terrain height map around a foot of the legged robot; and using the first terrain height map as the external perception information; or
obtaining a second terrain height map of an area of a specific shape beneath a reference location of the legged robot; and using the second terrain height map as the external perception information.

6. The method according to claim 5, wherein obtaining the first terrain height map around the foot of the legged robot comprises:
sampling ground heights based on at least two sampling radiuses by using the foot of the legged robot as a center, to obtain at least two ground sampling point heights; and
generating the first terrain height map based on a difference between a height of the foot and heights of the ground sampling point.

7. The method according to claim 1, further comprising:
obtaining sample proprioceptive information and sample external perception information;
inputting the sample proprioceptive information and the sample external perception information into the deep neural network, to obtain a sample predicted residual outputted by the deep neural network;
performing a parameter adjustment on the foot trajectory generator based on the sample predicted residual;
controlling the motion state of the legged robot based on a sample joint motion parameter outputted by the foot trajectory generator after the parameter adjustment;
determining a motion reward based on the motion state; and
training the deep neural network based on the motion reward.

8. The method according to claim 7, wherein the motion reward comprises at least one of an in-instruction speed reward or an out-of-instruction speed reward, and the in-instruction speed reward and the out-of-instruction speed reward are configured for encouraging the legged robot to move along an expected direction and at an expected speed; and
the method further comprises:
obtaining a body speed of the legged robot and a movement direction indicated by a movement direction instruction and determining the in-instruction speed reward based on the motion state by performing:
determining a default reward value as a first speed reward value when the body speed is greater than an expected lower speed limit and less than an expected upper speed limit; and using the first speed reward value as the in-instruction speed reward;
or
determining a second speed reward value based on the body speed, the movement direction, and an expected lower speed limit when the body speed is less than the expected lower speed limit; and using the second speed reward value as the in-instruction speed reward, the second speed reward value being less than a default reward value;
or
determining a third speed reward value based on the body speed, the movement direction, and an expected upper speed limit when the body speed is greater than the expected upper speed limit; and using the third speed reward value as the in-instruction speed reward, the third speed reward value being less than a default reward value; and
the method further comprises:
determining the out-of-instruction speed reward based on the motion state by performing:
determining the out-of-instruction speed reward based on the body speed and the movement direction, the out-of-instruction speed reward being in a negative correlation with a sub-speed of the body speed outside the movement direction.

9. The method according to claim 7, wherein the motion reward comprises an energy reward, and the energy reward is configured for encouraging the legged robot to reduce energy consumption during motion; and
the method further comprises determining the motion reward based on the motion state by performing:
obtaining a joint torque and a joint angular velocity of the legged robot;
determining a joint motion power based on the joint torque and the joint angular velocity; and
determining the energy reward based on the joint motion power, the energy reward being in a negative correlation with the joint motion power.

10. The method according to claim 7, wherein the motion reward comprises a foot terrain reward, and the foot terrain reward is configured for encouraging the legged robot to avoid a risky terrain; and
the method further comprises determining the motion reward based on the motion state by performing:
obtaining a foot terrain height of the legged robot, and determining a difference between a maximum value and a minimum value in the foot terrain height as a terrain height difference; and
determining a first value as the foot terrain reward when the legged robot is in a leg lift state or a bottom-touch state and the terrain height difference is greater than a risky terrain height threshold;
or
determining a second value as the foot terrain reward when the legged robot is in a bottom-touch state and the terrain height difference is less than a risky terrain height threshold.

11. The method according to claim 7, wherein the motion reward comprises a leg-lifting height reward, and the leg-lifting height reward is configured for encouraging the legged robot to lower a leg-lifting height; and
the method further comprises determining the motion reward based on the motion state by performing:
obtaining a leg-lifting height of the legged robot, the foot terrain height, and a sample leg-lifting height residual in the sample predicted residual;
determining a difference between a maximum value and a minimum value in the foot terrain height as a terrain height difference; and
determining a leg-lifting height difference based on the leg-lifting height, the sample leg-lifting height residual, the terrain height difference, and a leg-lifting height threshold;
determining the leg-lifting height reward based on the leg-lifting height difference when the leg-lifting height difference is greater than 0, the leg-lifting height reward being in a negative correlation with the leg-lifting height difference; and
when the leg-lifting height difference is less than or equal to 0, determining that the leg-lifting height reward is 0.

12. The method according to claim 7, wherein the motion reward comprises a smoothness reward, and the smoothness reward is configured for encouraging the legged robot to have a smooth gait; and
the method further comprises determining the motion reward based on the motion state by performing:
determining a joint angle difference of the legged robot at adjacent moments; and
determining the smoothness reward based on the joint angle difference, the smoothness reward being in a negative correlation with the joint angle difference.

13. A legged robot comprising one or more processors and a memory containing at least one computer instruction that, when being executed, causes the one or more processors to implement:
obtaining proprioceptive information and external perception information, the proprioceptive information being configured for characterizing a motion state of the legged robot, and the external perception information being configured for characterizing environment information around the legged robot;
inputting the proprioceptive information and the external perception information into a deep neural network, to obtain a first predicted residual outputted by the deep neural network, the first predicted residual being configured for correcting a trajectory generation parameter of a foot trajectory generator;
adjusting the trajectory generation parameter of the foot trajectory generator based on the first predicted residual; and
controlling the motion state of the legged robot based on a joint motion parameter outputted by the foot trajectory generator after the trajectory generation parameter is adjusted.

14. The legged robot according to claim 13, wherein the first predicted residual comprises a step frequency residual and a leg-lifting height residual, and the trajectory generation parameter of the foot trajectory generator comprises a step frequency parameter and a leg-lifting height parameter; and
the one or more processors are further configured to perform:
correcting a reference step frequency based on the step frequency residual, to obtain an adjusted step frequency parameter; and
correcting a reference leg-lifting height based on the leg-lifting height residual, to obtain an adjusted leg-lifting height parameter.

15. The legged robot according to claim 14, wherein an output of the deep neural network further comprises a second predicted residual, and the second predicted residual is configured for correcting the joint motion parameter outputted by the foot trajectory generator; and
the one or more processors are further configured to perform:
obtaining the joint motion parameter outputted by the foot trajectory generator after the trajectory generation parameter is adjusted;
correcting the joint motion parameter based on the second predicted residual; and
controlling the motion state of the legged robot based on the corrected joint motion parameter.

16. The legged robot according to claim 15, wherein the deep neural network is a long short-term memory (LSTM) network, and the one or more processors are further configured to perform:
using a movement direction instruction, a historical motion parameter of the legged robot, and a historical predicted residual as the proprioceptive information, the historical predicted residual comprising a historical first predicted residual and a historical second predicted residual that are outputted by the deep neural network.

17. The legged robot according to claim 13, wherein the one or more processors are further configured to perform:
obtaining a first terrain height map around a foot of the legged robot; and using the first terrain height map as the external perception information; or
obtaining a second terrain height map of an area of a specific shape beneath a reference location of the legged robot; and using the second terrain height map as the external perception information.

18. The legged robot according to claim 17, wherein the one or more processors are further configured to perform:
sampling ground heights based on at least two sampling radiuses by using the foot of the legged robot as a center, to obtain at least two ground sampling point heights; and
generating the first terrain height map based on a difference between a height of the foot and heights of the ground sampling point.

19. The legged robot according to claim 13, wherein the one or more processors are further configured to perform:
obtaining sample proprioceptive information and sample external perception information;
inputting the sample proprioceptive information and the sample external perception information into the deep neural network, to obtain a sample predicted residual outputted by the deep neural network;
performing a parameter adjustment on the foot trajectory generator based on the sample predicted residual;
controlling the motion state of the legged robot based on a sample joint motion parameter outputted by the foot trajectory generator after the parameter adjustment;
determining a motion reward based on the motion state; and
training the deep neural network based on the motion reward.

20. A non-transitory computer-readable storage medium containing at least one computer instruction that, when being executed, causes at least one processor to perform:
obtaining proprioceptive information and external perception information, the proprioceptive information being configured for characterizing a motion state of the legged robot, and the external perception information being configured for characterizing environment information around the legged robot;
inputting the proprioceptive information and the external perception information into a deep neural network, to obtain a first predicted residual outputted by the deep neural network, the first predicted residual being configured for correcting a trajectory generation parameter of a foot trajectory generator;
adjusting the trajectory generation parameter of the foot trajectory generator based on the first predicted residual; and
controlling the motion state of the legged robot based on a joint motion parameter outputted by the foot trajectory generator after the trajectory generation parameter is adjusted.
